(19) United States
(12) Patent Application Publication
(10) Pub. No.: US 2012/0185254 A1
(43) Pub. Date: Jul. 19, 2012

(54) INTERACTIVE FIGURINE IN A COMMUNICATIONS SYSTEM INCORPORATING SELECTIVE CONTENT DELIVERY

(76) Inventors: William A. Biehler, San Diego, CA (US); Gary W. Smith, San Diego, CA (US)

(21) Appl. No.: 13/352,508

(22) Filed: Jan. 18, 2012

Related U.S. Application Data
(60) Provisional application No. 61/461,446, filed on Jan. 18, 2011.

(51) Int. Cl. G10L 21/00; G06F 15/16; H04Q 5/22

(52) U.S. Cl. 704/270; 340/10.1; 709/217; 704/E21.001; 704/E13.001

(57) ABSTRACT

In a system, an interactive figurine delivers messages to a user in one of a number of forms. A server operation system includes processing capability which may individually couple content or may customize messages to a particular user of the interactive figurines. The interactive figurine contains an embedded circuit consisting of a receiver comprising a detector circuit tuned to at least one preselected frequency, a decoder to provide information indicative of intelligence and signals sent to the receiver, and a decoder circuit to provide actionable output signals indicative of information transmitted to the receiver. The server operation system may include a subscriber database and administration routines for customizing of messages and for directing messages. A user station intermediate the interactive figurine and the server module may be used to provide parental control or other control.

### CROSS-REFERENCE TO RELATED APPLICATIONS

This application claims priority from provisional application Ser. No. 61/461,446, entitled “Natural Voice Communication Through an Interactive Figurine and System,” filed on Jan. 18, 2011. The contents of this provisional application are fully incorporated herein by reference.

### BACKGROUND OF THE INVENTION

1. Field of the Invention

The present subject matter relates to a system, subsystems, and method for an individual to send textual or recorded voice messages to users which are delivered to the user via an interactive figurine

2. Background

Figurines of various forms are known which receive intelligence from RF signals transmitted from a remote source. Particular voice capabilities can be provided. However, processing capabilities of systems including such figurines have been limited.

A subsystem including decoding circuitry provides intelligence which is translated to audio outputs. The figurine appears to speak to a user. An example is the GPS Teddy Bear made by iXs Research Corp. of Yokohama, Japan.

U.S. Pat. No. 6,290,566 discloses an interactive talking figurine in a system in which the figurine interacts with a computer radio interface. The user may speak to the computer and stimulate action. Translation software in the computer allows a user to speak to the figurine in a first language and receive a response in another language. This interaction does not include a transmission to the user of an outside message from a third party via the figurine.

U.S. Pat. No. 7,008,288 discloses an intelligent figurine with Internet connection capability. The system includes a computer and software for controlling operation of the device in accordance with the user's personal profile or local environment. The computer can provide instructions to the device for controlling operation of the device based on gathered data and in response to a stored user's profile.

U.S. Pat. No. 7,818,400 discloses an interactive communications appliance for broadcasting a set of information selected by the user. A memory stores the selected information, and an audio device broadcasts the information to a user. The information may comprise programming streamed from the Internet. The appliance may be programmed to make remarks about the received content. Text may be converted to speech. However, the information received by the appliance is a collection of content selected from outside sources. There is no selection of content which can be produced by a system operator for provision to users.

United States Patent Application Number 2006/0239469 discloses a story-telling doll which contains a processing system having a digital processor, a storage device, and an output audio device. A processing system can initiate a data communications link with a remote content provider source to request a download of a data file which may comprise a story. The data file is saved, and the audio is played. This processing system only requests a set of information for download and then plays it. Text-containing files may be processed by a speech synthesizer. The speech produced by the synthesizer is not made to correspond with a particular source.

United States Patent Application Number 2010/0041304 discloses an interactive networked figurine system comprised of objects that enter into “a meaningful and entertaining dialogue” with each other and a user. Each figurine has an internal data storage means that comprises its “personality.” The figurine interacts with prepackaged scenarios on specific topics.

### SUMMARY

In accordance with the present subject matter, there are provided an interactive figurine, a system, and subsystems. The system may be viewed as comprising interactive subsystem modules. The interactive figurine delivers messages to a user in one of a number of forms. The interactive figurine also includes processing capability which may individually customize messages to a particular user and make other decisions regarding reception and transmission of data.

The content is delivered by a server module that the user has been authorized to use. When a user accesses the server module it interrogates the user's toy as to its capabilities. Upon successful access, a “single stream of code” comprised of synchronized motion command and audio/video control signals are delivered to the toy.

While this subject matter can be used with people of all ages, one class of users may comprise individuals that will require the assistance of an adult or parent with operating knowledge of computers and the Internet. One example of such a class is children aged 2-8 years. The present system provides for Parental Control or other forms of control of the content that is delivered to the user.

The user or controlling entity has the ability to determine the content stream based on a selected set of data comprised of matching periodic surveys of currently popular sayings, songs, sounds, and stories. The selected set of data may be determined with the assistance of an algorithm whose components include ratings by groups of individuals that have aligning demographics and preferences, recognized child behavioral authorities, and trending purchase decisions of selected groups.

Further, the system can “determine” the content stream based on a library of “key words” or preferences selected, such as the demographics of the user, the time of day and/or location of the user.

The interactive figurine contains an embedded circuit consisting of a receiver comprising a detector circuit tuned to at least one preselected frequency, a decoder to provide information indicative of intelligence and signals sent to the receiver, and a decoder circuit to provide actionable output signals indicative of information transmitted to the receiver. A text channel may be provided comprising a decoder for a digital stream indicative of received text messages. The text-to-speech generator may also comprise a phoneme library corresponding to a voice of a preselected character and a natural voice processor to produce a customized message in the voice of a specific character.

The digital stream is provided to a text-to-speech converter. A voice channel includes a detector to, in one form, provide a digital stream coupled to a digital to analog converter. Both channels provide an output to an audio driver. A transducer, for example a speaker, produces sounds in response to the audio output signals. A display may also be provided to display the text, or other interactive media content, e.g. video, pictures, etc.

Intelligence from the character is provided from a message origin subsystem module via a server. The server may include a subscriber database and administration routines for customizing of messages and for directing messages. Messages may be provided to a user via the Internet through a user subsystem module at a user station. A personal computer and a transceiver communicating with the figurine may be included in the user station. In one alternative form, the interactive figurine may respond to signals from a local subsystem module such as a home entertainment system.

In one present embodiment, received input signals are detected as text or voice inputs. A decoder circuit provides actionable output signals indicative of information transmitted to the receiver. A text channel comprises a decoder which decodes a digital stream indicative of received text messages. The digital stream is provided to a text-to-speech converter. A voice channel includes a detector to, in one form, provide a digital stream coupled to a digital to analog converter. Both channels provide an output to an audio driver.

The present subject matter also comprises a computer program product comprising a plurality of applications embodied in a computer-usable medium having a computer readable program code embodied therein. The computer-readable program code is adapted to be executed on a digital processor. One program generates a voice output from the interactive figurine in a system comprising distinct software modules, and wherein the distinct software modules comprise a first and a second logic processing module, wherein said first logic processing module comprises a digital decoder and the second logic processing module comprises a text to speech converter configuration file processing module, a data organization module, and a data display organization module.

In accordance with the present subject matter, the system may query the interactive figurine as to its structure and capabilities in order to customize a stream of code delivered to the figurine. One form of customization comprises structuring the architecture of digital data packets.

The messages in a further alternative form may be delivered to an intelligent portable device which may use an avatar to simulate a figurine.

### BRIEF DESCRIPTION OF THE DRAWINGS

FIG. 1 is an illustration of a system and subsystems incorporating the present subject matter;

FIG. 2 is a block diagram illustrating subsystems with the present system providing an overview of their interaction;

FIG. 3 is a block diagram of an interactive figurine;

FIG. 4 is a block diagram illustrating coding, decoding, and transcoding within the present system;

FIG. 5 is a block diagram of a server subsystem;

FIG. 6 is a block diagram of an intelligent device subsystem;

FIG. 7a illustrates a graphical menu on the display of an intelligent device, the menu comprising an array of applications;

FIG. 7b illustrates a display which may be provided on the interactive device to provide a two-dimensional or 3D image of an avatar which may communicate with a user;

FIG. 8 illustrates selections from a suite of applications that may be selected for use in the intelligent device subsystem;

FIG. 9 is a flow chart illustrating a program that provides general or personalized messages to a user;

FIG. 10 is an illustration of the encoding of signals representing physical functions of an interactive toy; and

FIG. 11 illustrates the use of the interactive figurine as a proxy player in online game play.

### DETAILED DESCRIPTION

The present subject matter provides for natural voice communication through an interactive figurine and for a system, subsystem, and method to deliver various forms of messages via differing protocols to the figurine.

The interactive figurine includes processing capability which may individually customize messages to a particular user and make other decisions regarding reception and transmission of data. The user has the ability to determine the content stream based on a selection set of data comprised of matching periodic surveys of currently popular sayings, songs, sounds and stories as determined by an algorithm whose components include ratings by groups of individuals that have aligning demographics and preferences, recognized child behavioral authorities and trending purchase decision data.

The content is delivered by a server module the user has been authorized to use. When a user accesses the server module it interrogates the user's toy as to its capabilities. Upon successful access, a “single stream of code” comprised of synchronized motion command and audio/video control signals are delivered to the toy.

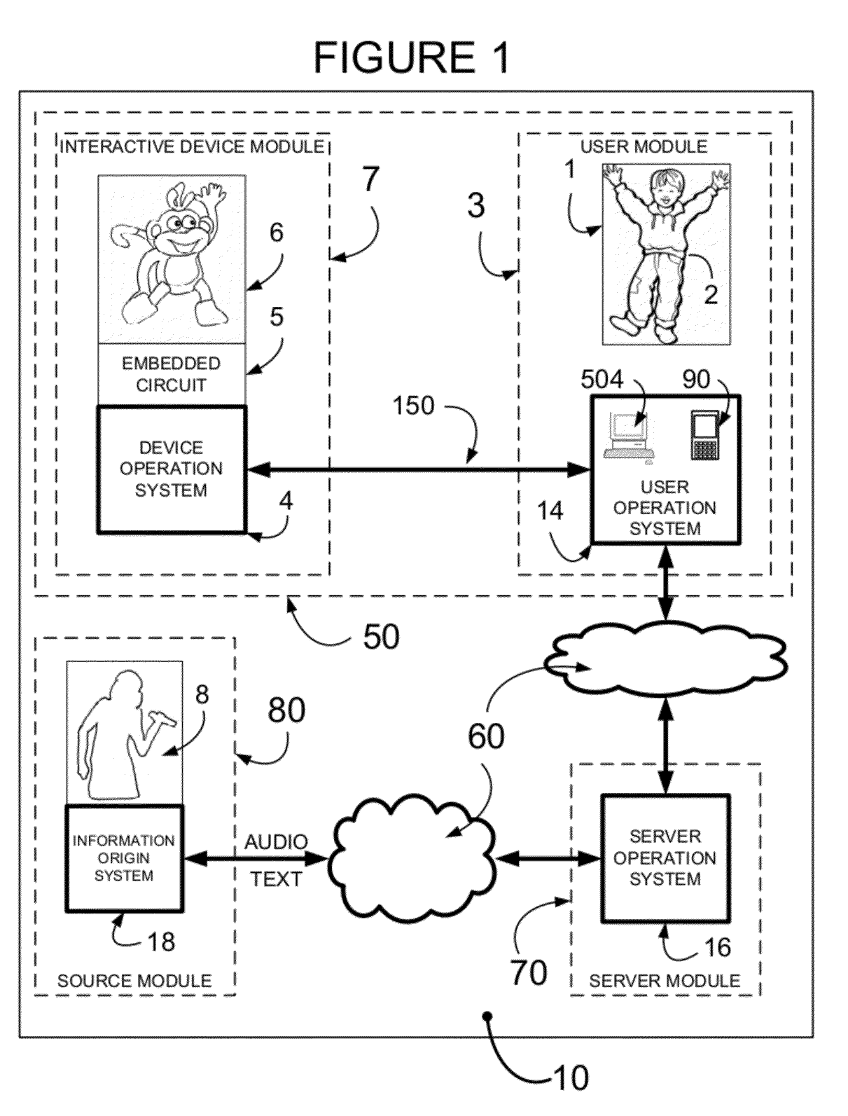

FIG. 1 is an illustration of the operational units of a natural voice communication system 10 and various subsystems incorporating the present subject matter. A user 1 at a user module 3 is illustrated in the present embodiment in the form of a child 2. The user 1 could be an individual or a plurality of individuals. While a child 2 is selected in the present illustration, a user could be an adolescent or an adult. The user module 3 includes a user operation system 14.

The user 1 will interact with an interactive device module 7 in the form of a figurine 6. The term “figurine” is used in the present description for convenience. The figurine 6 could also be described as a toy or an effigy. The figurine 6 need not necessarily comprise an object having play value. In the present illustration, the figurine 6 is shown as a plush toy. The figurine 6 could be virtually any object of interest to a particular type of user 1. The figurine 6 could comprise an effigy of a sports figure or an entertainer, for example. Alternatively, the figurine 6 could be a non-anthropomorphic representation of a vehicle or other object. For example, the figurine 6 could be an effigy of a race car which talks to an adult who is watching a racing event. Preferably, the figurine 6 includes an embedded circuit 5 and a device operation system 4.

The figurine 6 may include among its functions speaking to the user 1 in the voice of a character 8. The character 8 may provide an input at source module 80. “Character” is used to describe an entity that will be recognizable to a set of users. In many applications, the character 8 may be a human celebrity, a grandmother, or a fictional character as voiced by a selected human. Alternatively, the character 8 could comprise a non-human which produces sounds other than human speech. Other forms of audio provided from a character could include speech of whales or porpoises.

The natural voice communication system 10 is interconnected through individual communication and processing subsystem modules at various locations. In a preferred embodiment of the communication system structure, the Internet 60 facilitates the required communication links between the user operation system 14 and the information origin system 18 via a server operation system 16 within a server module 70. Communication between the user operation system 14 and the device operation system 4 is accomplished by various means of communication protocols and structures. The physical structure of the communication link can be wired or wireless. It can use radio frequency (RF), infrared, or other form of signals. The preferred embodiment illustrates an RF link 150. A device operation system 4 provides the communication and processing functionality for the figurine 6 by means of an embedded circuit 5. The embedded circuit 5 provides the required functionality for the device operation system 4. Together, the figurine 6, embedded circuit 5, and the device operation system 4 comprise the interactive device module 7. As further described below, the interactive device module 7 comprises transducers for selectively operating in response to intelligence-bearing signals. The interactive device module 7 may also include means for generating intelligence-bearing signals.

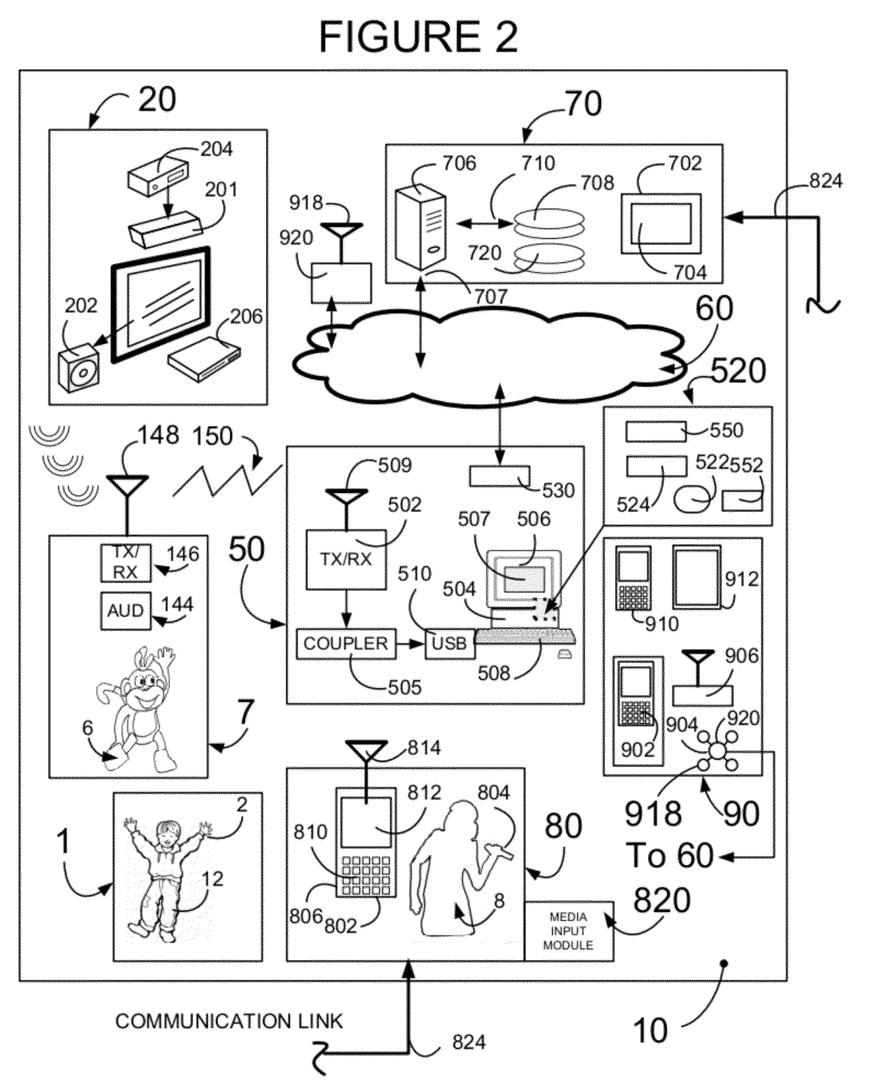

The interactive device module 7 is interconnected to the user module 3 via an RF link 150 and may be co-located at a user location 50. The user module 3 comprises the user 1 and the user operation system 14 which could include a personal computer 504 or mobile media device 90 (FIG. 2) with Internet capability. In a preferred embodiment, the user operation system 14 would comprise a smart phone 902 (FIG. 2) with the applicable user interface and software programming necessary for the system. The user operation system 14 is connected to the server operation system 16 via the Internet 60. The character 8 is interconnected via various means to the server operation system 16. In a preferred embodiment of the current subject matter, the information origin system 18 could comprise a smart phone 802 (FIG. 2) with a user interface and software applications required by the system that are operative to create and send textual or voice recordings to the server operation system 16 via the Internet 60.

FIG. 2 is a block diagram illustrating subsystems within the system 10. An overview of the interaction of subsystems is provided. Further specific details of subsystems are described below. The configurations of the subsystems within the system 10 are suitable for achieving the below-described objectives. However, it is not essential that functions be distributed as illustrated in FIG. 2. Other configurations may be provided in accordance with the teachings of the specification.

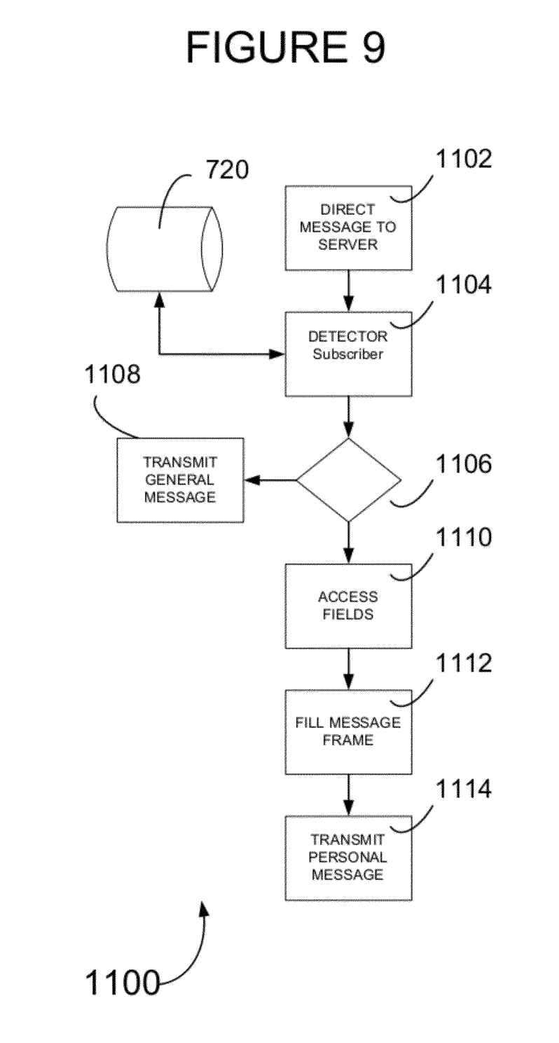

Subsystems may also include a home entertainment center 20. The home entertainment center 20 need not necessarily be located in a home, but includes components that may be included in a home entertainment system such as a cable box or a media player further described below. Other subsystems are as follows. A user station 50 comprises components that may be connected to the Internet 60, e.g., a personal computer 504. The user station 50 may comprise a content control for parental or other control, as further described with respect to FIG. 9. A server module 70 may include a server for coordinating provision of services by an administration company 702 through an administration company computer 704. A source module 80 includes the necessary transducers which provide signals from the character 8. Further resources may be included in the message origin location and source module 80 and are further described below. An intelligent device module 90 includes devices such as smart phones, tablet computers, laptops, or notebooks that provide computing capability and Internet connectivity.

In the interactive device module 7, the figurine 6 includes an audio output device 144 to provide audio to the user 1. A transceiver 146 receives and transmits signals providing for interaction via an antenna 148. The signal link 150 will commonly be an RF link. The present subject matter may comprehend interaction utilizing many different forms of communication, media in the home entertainment system 20, networks, protocols, and data. Most preferred embodiments will be discussed in the context of wide area networks (WANs). However, the figurine 6 may interact in a local area network (LAN).

The home entertainment system 20 generally will receive program materials such as television programs and movies. In many embodiments, the home entertainment system 20 will comprise a television receiver 201 supplying sound to a speaker 202. The television receiver 201 may receive signals from sources such as a cable box 204 or a media player 206, which could be a DVD player. The cable box 204 may receive cable network or broadcast transmissions.

In one preferred form, the user station 50 comprises a user computer 504, a monitor 506, and a keyboard 508. The user computer 504 may provide a graphical user interface (GUI) 507 on the monitor 506. The RF link 150 is coupled to the user computer 504 by a coupler 505 having an antenna 509. One form of coupler 505 is an RF card comprising a transceiver 502 having an antenna 509. The coupler 505 may plug into a computer slot in the user computer 504. The coupler 505 may connect to the user computer 504 through a USB dongle 510 in order to control access of RF signals to the user computer 504. A keyboard 508 may provide an input to the user computer 504. The user station 50 will usually interface with content from the server station via the Internet 60 through a modem 530. The user station 50 couples content from the server module 70 to the figurine 6 and receives inputs from the figurine 6 for interaction as described below.

Within the computer 504, a programming processing section 520 is established. In preferred forms, the programming processing section 520 will comprise a data memory 522 including applications resident on storage in the computer 504. Additionally, specific data as further described below associated with the subscribers will be included. The computer 504 may receive communications via the Internet 60. These communications could include e-mail, streaming audio, and video, and media broadcasts via the Internet. A particular current form of communication may be displayed on the graphical user interface 507.

The programming processing section 520 reads signal inputs from the modem 530 in order to use tags provided in media such as parental control information, program identity, or digital rights management (DRM) data. A parent or other control authority may provide input, such as by use of the keyboard 508, to control content provided to the figurine 6.

In a number of embodiments, the computer 504 will provide an alternative to networks including cell phones or broadcast links. However, additional local functions may be provided. An application 524 provides for local customization of responses to be provided by the figurine 6. The application 524 may also transmit subscription information to the server module 70. The application 524 may also be used to interact with the subscription database 720. The computer 504 may also interact with downloadable programming to provide alternative performance for the figurine 6.

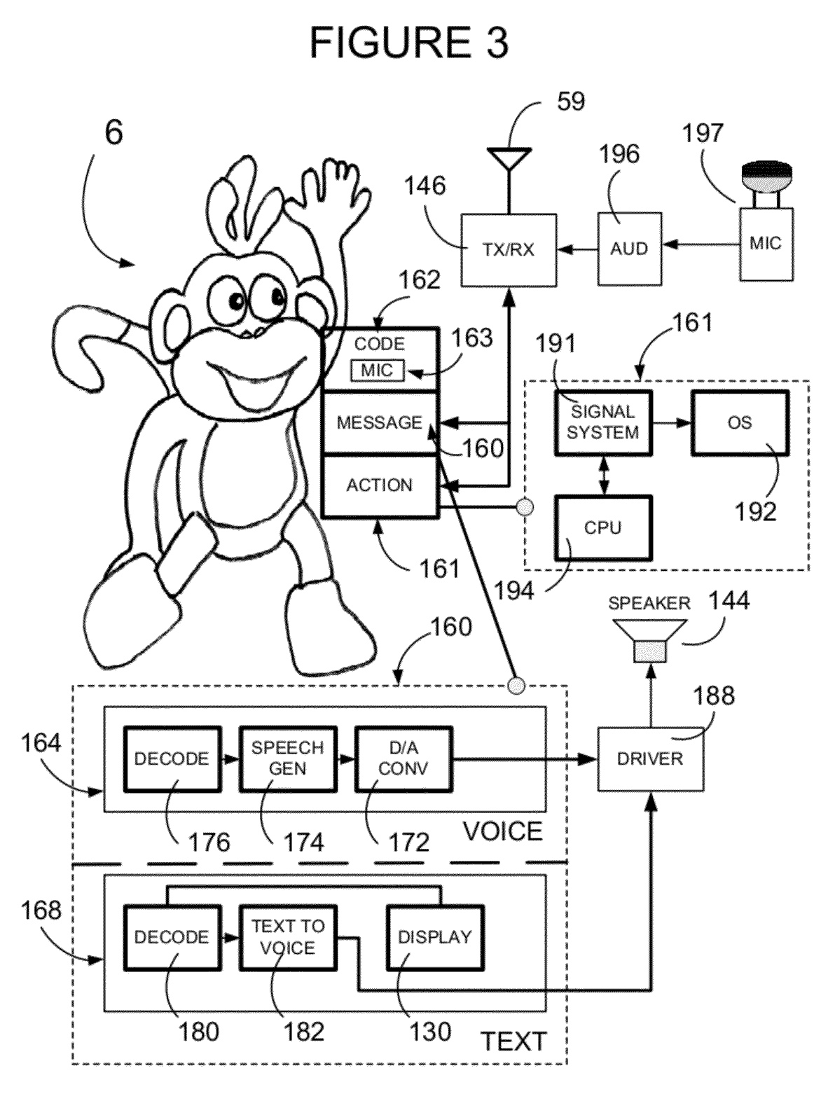

In one form, the processor further comprises an interrogation circuit 550 for interaction with the code circuit 162 of FIG. 3. The interrogation circuit 550 commands generation of a signal to be transmitted, e.g., by the transceiver 502 to the interactive device module 7. The component data is indicated by the output of the code circuit 162, e.g., a selected number. The processor 520 may house a program 552 which interprets the signal received form the code circuit 162. The program 552 may be provided to the user station 50 from the administration company 702 (see below). The maker of the code circuit 162 uses a routine to provide information useful to the program 552. Alternatively, program 552 may be sold at retail in a package or be downloadable.

In order to provide control signals customized to the action circuit 161 (FIG. 3), the output of the interrogation circuit 550 commands the processor 520 to produce signals to operate the figurine 6. The computer 504 may read signals coming from the server module 70 and command production of command signals in correspondence with incoming information. Alternatively, the program 552 may generate control signals in correspondence with incoming information. The provision of a customized set of command signals could alternatively be performed in the server module 70. Upon processing of input signals and the information from the code circuit 162, a “single stream of code” comprised of synchronized motion command and audio/video control signals is delivered to the figurine 6. A customized stream of code is delivered to the figurine 6. One form of customization comprises structuring the architecture of digital data packets.

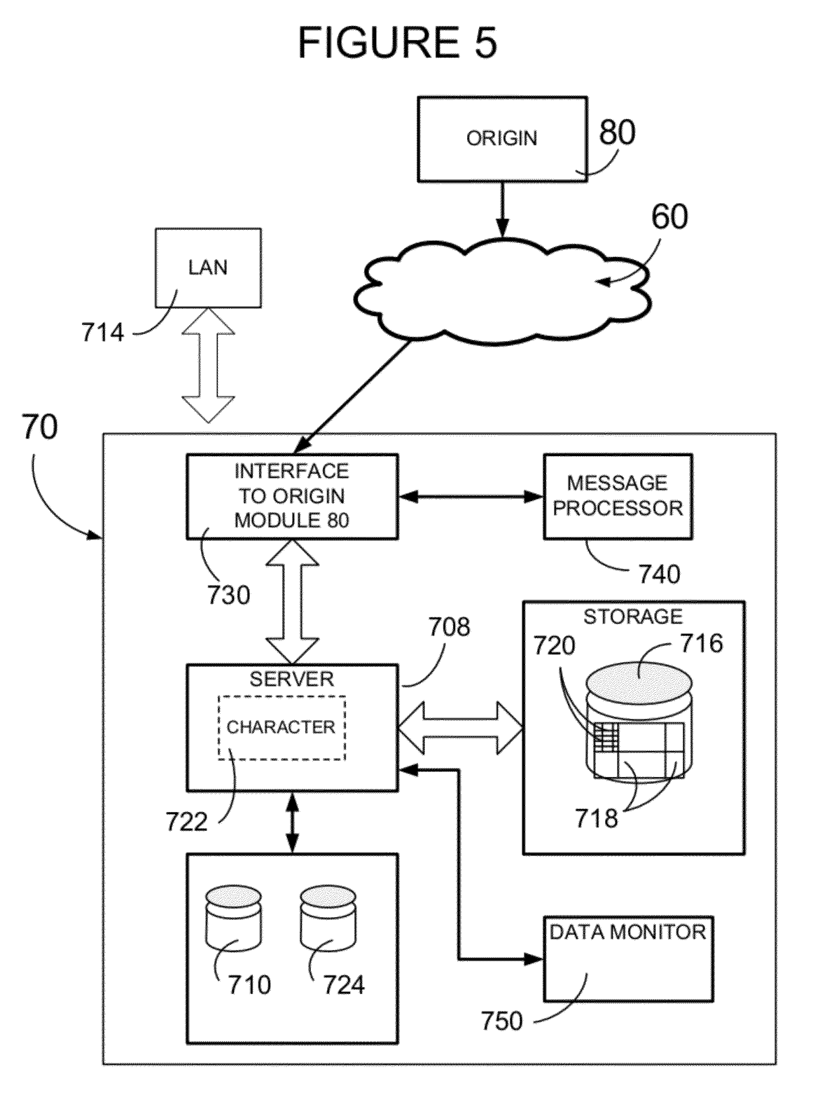

In the present system, the server module 70 may act as a central data controller. The present subject matter is suitable for use in a subscription service. In one subscription service embodiment, data input and data output from the server module 70 are controlled by the administration company 702 using the administration company computer 704. The administration company 702 may provide services to users. Alternatively, the administration company 702 may provide contract services to a major provider such as a cable carrier or an MP3 Internet service. A server 706 having a network interface 707 receives data and sends data to and from a database 708 via an interface 710 in the server module 70. The server module 70 is described in greater detail with respect to FIG. 5 below. As further described with respect to FIG. 9 below, the server module 70 may have the ability to determine a content stream based on a library of key words or preferences selected, such as the demographics of the subscriber, the time of day, and/or location of the subscriber.

Content is provided to the system through the source module 80, which may take any of a number of forms. The source module 80 represents an entry point into the system 10 for content such as audio or video or of actionable intelligence. The source module 80 could be a physical element of the system or a conceptual element comprising distributed components. Generally, the actionable intelligence is provided by the character 8. The actionable intelligence is provided to an input device 802, which may include any one of a number of means for translating an action by the character 8 into a message. In the present illustration, the input device 802 includes a microphone 804 held by the character 8. Another element of the input device 802 may be an intelligent device such as a smart phone 806 having a texting keyboard 810, display 812, and antenna 814. Additionally, a microphone and audio output may be provided in the smart phone 806. Forms of media may also be provided to the server module 70 from a media input module 820. The media input module 820 is connected to media sources such as television, media, or audio. The media input module may be connected to the server module 70 via a communications link 824. Other subsystems may provide input information to the source module 80.

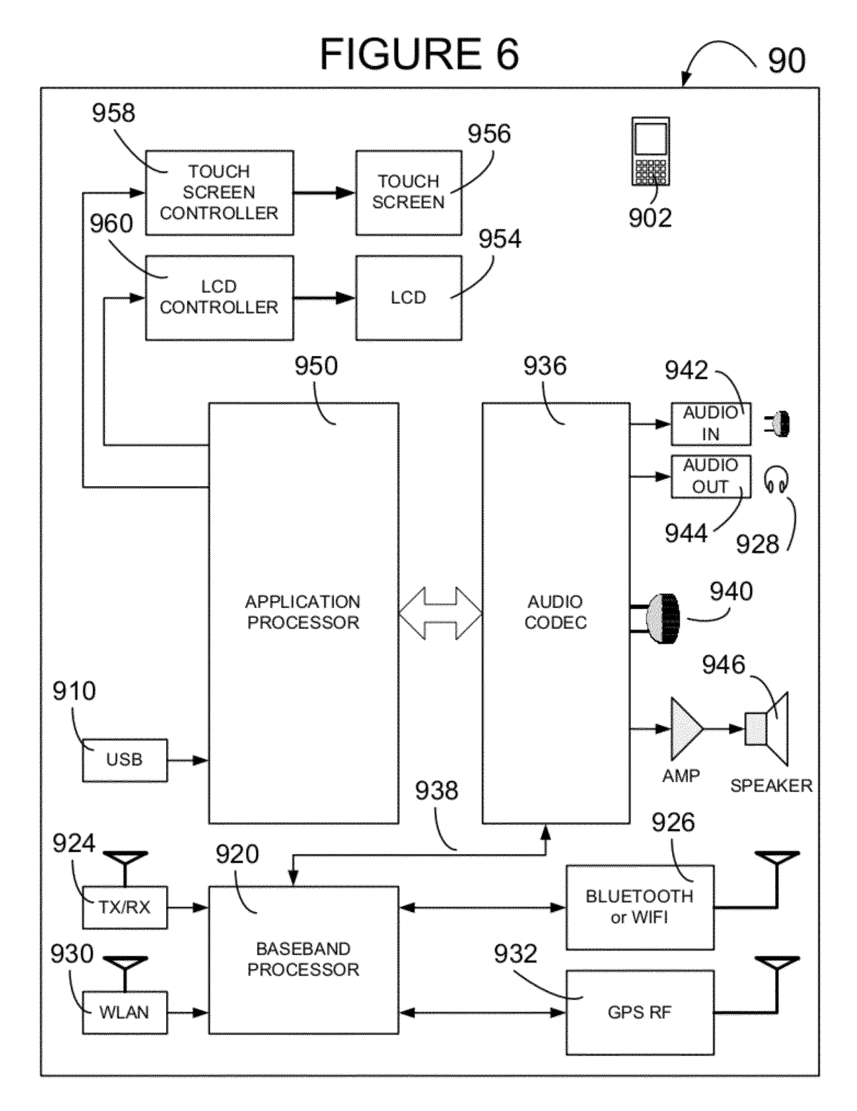

Actionable intelligence may be provided to and from the system 10 by an intelligent device subsystem 90, including at least one intelligent device 902. In many preferred embodiments, the intelligent device subsystem 90 will comprise a mobile device. This is not, however, essential. Intelligent device 902 may comprise a remote source for the source module 80. The intelligent device subsystem 90 may, for example, provide information to the source module 80. The intelligent device subsystem 90 is illustrated further below with respect to FIG. 6. The intelligent device 902 may be selectively connected to one or more of a cell phone network or wide area network interface 906. The cell phone network 904 and wide area network 906 may each link to the Internet 60. Preferred forms of the intelligent device 902 could comprise, for example, a smart phone 910 with computer capabilities or a tablet computer 912 with telephone capabilities. As the process of device convergence continues, the difference between these two sorts of devices will likely become less and less significant. The smart phone network 904 may comprise a cell phone tower 918 which is connected to a carrier 920. The carrier 920 may connect communications to the Internet 60. Where the intelligent device 902 is a personal computer, the wide area network 906 will interface with the intelligent device subsystem 90 by a modem.

The character 8 may enter an e-mail message, SMS text message, or a proprietary network message such as a “Tweet.” Tweet is a text message of up to 140 characters that is distributed on a network known as Twitter®. Alternatively, the character 8 may create a real-time voice message. Alternatively, the character 8 may provide a remotely originated communication via the tablet computer 912. The communication can provide voice, e-mail, or a text message. The source module 80 may interact with the server module 70 for such functions as real-time streaming, as further described below.

FIG. 3 is a block diagram of the figurine 6. The figurine 6 may include a message processing system 160, an action system 161, and a code system 162. The message processing system 160 is primarily concerned with communications between the figurine 6 and input sources and output recipients. The action system 161 is primarily concerned with physical interactions of the figurine 6, and the code system 162 is concerned with signaling to an outside control signal source the type and format of control signals to which it will respond. The characterization of the figurine 6 as comprising systems 160, 161, and 162 is for purposes of description. This characterization does not limit the structure or operation of the present embodiments. The below-described processors may be embodied in known forms of integrated circuits. They need not comprise discrete units. In accordance with one aspect of the present subject matter, the digital circuitry may be embodied in an ARM processor, a commercially available 32-bit RISC (reduced instruction set computer) architecture processor.

The code circuit 162 may interact with the interrogation circuit 550 of FIG. 2. A signal transmitted from the user station 50 interacts with the figurine 6 to sense capabilities of the figurine 6 and to generate code having a structure consistent with the capabilities of the figurine 6. The code circuit 162 may be queried by the interrogation circuit 550 via the transceiver 146. The code circuit 162 generates signals indicative of the types of control signals to which it will respond. There are many ways to embody this function. For example, the code circuit 162 store a number indicative in a configuration memory 163 of a configuration of the figurine 6, i.e., identification of components which can be commanded and the signal protocols which operate them.

The message processing system 160 receives signals from the transceiver 146. The message processing system 160 includes a first channel 164 and a second channel 168. The channel 164 is a voice processing channel. The channel 164 includes a decoder 176 receiving a digital data stream from the transceiver 146. The decoder 176 provides signals indicative of voice information to a digital to analog converter 172. The digital to analog converter 172 translates the digital stream into analog signals supplied to an audio driver 188. The voice processing channel 164 may further comprise a speech generator 174 connected intermediate the decoder 176 and the analog to digital converter 172. The speech generator 174 comprises a processor program to generate the voice information in the diction of a preselected carrier. This conversion is discussed in further detail below.

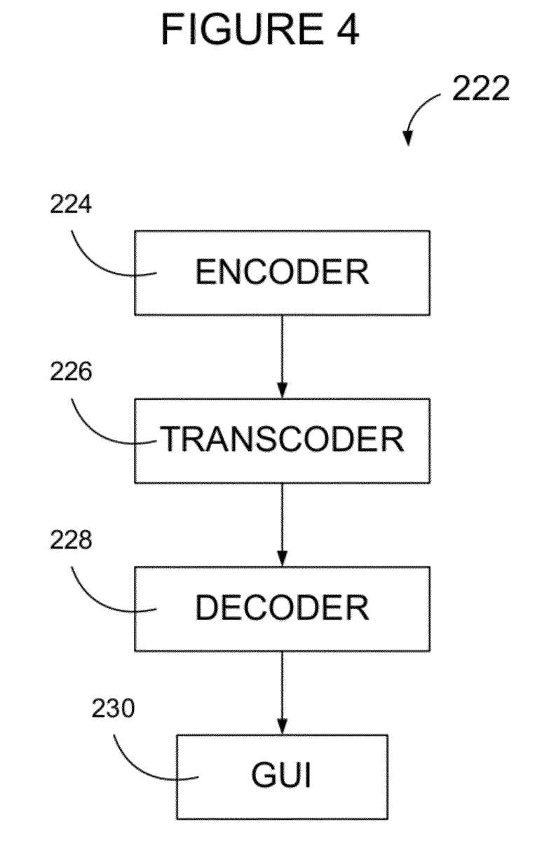

The channel 168 is a text channel and includes a text decoder 180 that provides an output to a text to voice converter 182. The text to voice converter provides an audio signal to the audio driver 188. The audio driver supplies analog input to a speaker 144. The speaker 144 may be placed in the head of the figurine 6 to better simulate speaking A display 130 capable of displaying text is coupled to an output of the text decoder 180. The circuitry in the text-to-voice converter 182 is illustrated in further detail in FIG. 4 below. The software for operating the text-to-voice converter 182 and transporting information is also disclosed by FIG. 4 below.

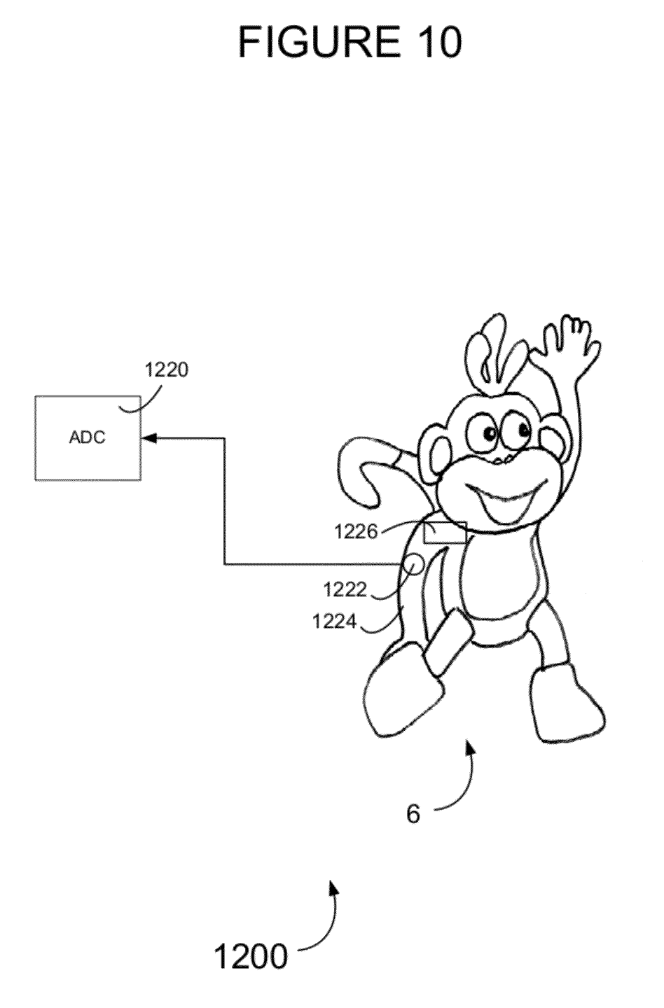

The action system 161 may include a signal system 191 to receive control signals and for operating subsystems 192 for performing functions such as animatronics to operate portions of the figurine 6. The operating subsystems 192 may include servo motors and linkages, for example as seen in FIG. 10. A processor 194 processes input signals and provides instructions. An audio input circuit 196 may be used to provide an input to the transceiver 146 supplied from a microphone 197. This can allow a user 1 to speak to the figurine 6 so that the signal is transmitted from the transceiver 146 to the transceiver 502 at the user station 50 (FIG. 2). The CPU 504 may include circuitry for accessing information to respond to intelligence that is transmitted from the user 1 (FIG. 2).

FIG. 4 is a block diagram of illustrating coding, decoding, and transcoding within the present system. Systems use various building blocks. FIG. 4 illustrates the manner of signal translation where diverse protocols are used. In FIG. 4, an encoding module 222 includes an encoder 224 that translates a first input into another form. For example, a text message may be encoded into an e-mail format. An encoder is a device, circuit, transducer, software program, algorithm, or person that converts information from one format or code to another, for the purposes of standardization, speed, secrecy, security, or saving space by shrinking size. The encoded message is then transmitted.

When moving from a medium embodying a first protocol to a medium embodying a second protocol, the message is then coupled through a transcoder 226. Transcoding can be found in many areas of content adaptation. However it is commonly used in the area of mobile phone content adaptation. In the world of mobile content, transcoding is a must, due to the diversity of mobile devices. This diversity requires an intermediate stage of content adaptation in order to make sure that the source content will adequately be presented on the target device it is sent to. An output is coupled via decoder 228 through a readout device 230 such as a display in a graphical user interface or a speaker.

FIG. 5 is a block diagram of a server module 70 including the server 706. The server module 70 may be operated as a control center for the transmission and translation of messages within the present system. The server 706 includes a data section 710 which may also be used to store data for operation of the other subsystems described herein. Interaction with the server module 70 may be via the Internet 60 or any local area network (LAN) 714. The server 706 may include a first subscriber database 716 which stores data indicative of subscribers to a service providing communications from the character 8. The subscriber database 716 comprises a plurality of locations 718, each corresponding to a subscriber. Each location 718 includes a plurality of fields 720. The fields 720 may include information such as identity of each subscriber, identity of subscription services, personalization information, and other information which may be entered and updated by the administration company 702 (FIG. 2) and the administration company computer 704 (FIG. 2). Types of information stored in the data section 710 may be referred to as data entities.

The server 706 further comprises a character computer section 722. Character computer section 722 includes character database storage 724 for information regarding the character 8, messages provided by the character 8, and programming information including data for scheduling transmission of messages stored in the server 706. The server 706 further comprises an interface 730 for communicating with the source module 80 (FIG. 2). A message processor 740 is provided for encoding, decoding, and transcoding of messages sent through the intelligent device subsystem 90 (FIG. 2) as appropriate. A data monitor 750 may be provided coupled to data useful in selecting content in accordance with characteristics of subscribers. Inputs to the data monitor may include sources of ratings by groups of individuals that have aligning demographics, recognized child behavioral authorities, and trending purchase decisions of selected groups. Data indicative of characteristics of a subscriber from the database 716 may be correlated with data from the data monitor by the server 706 to control selection of data from the source module 80 for provision to a user 1.

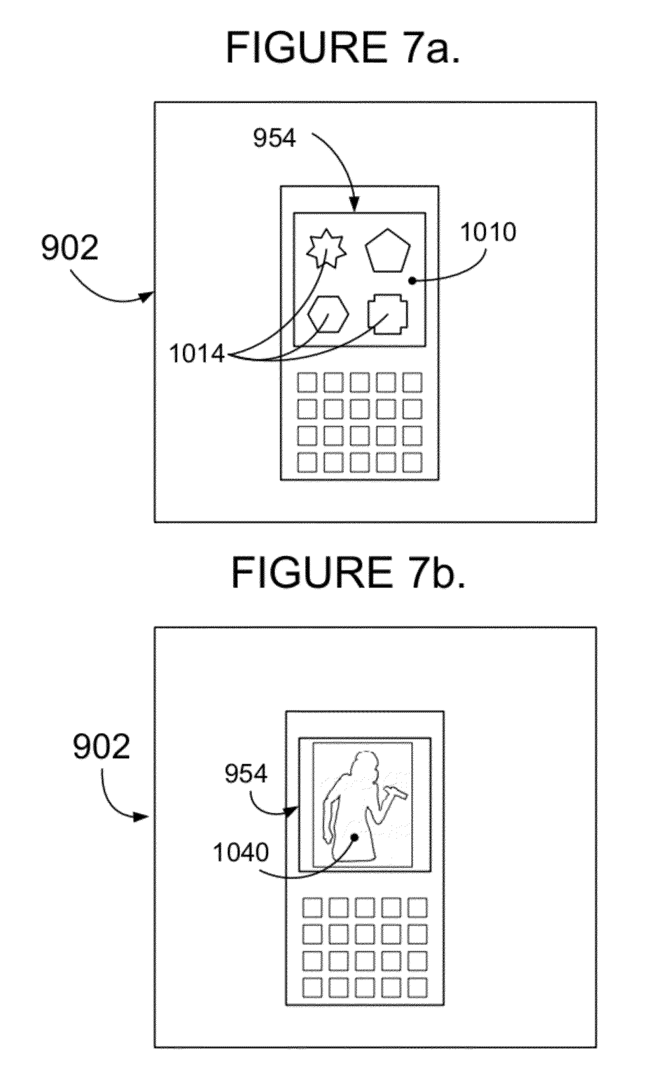

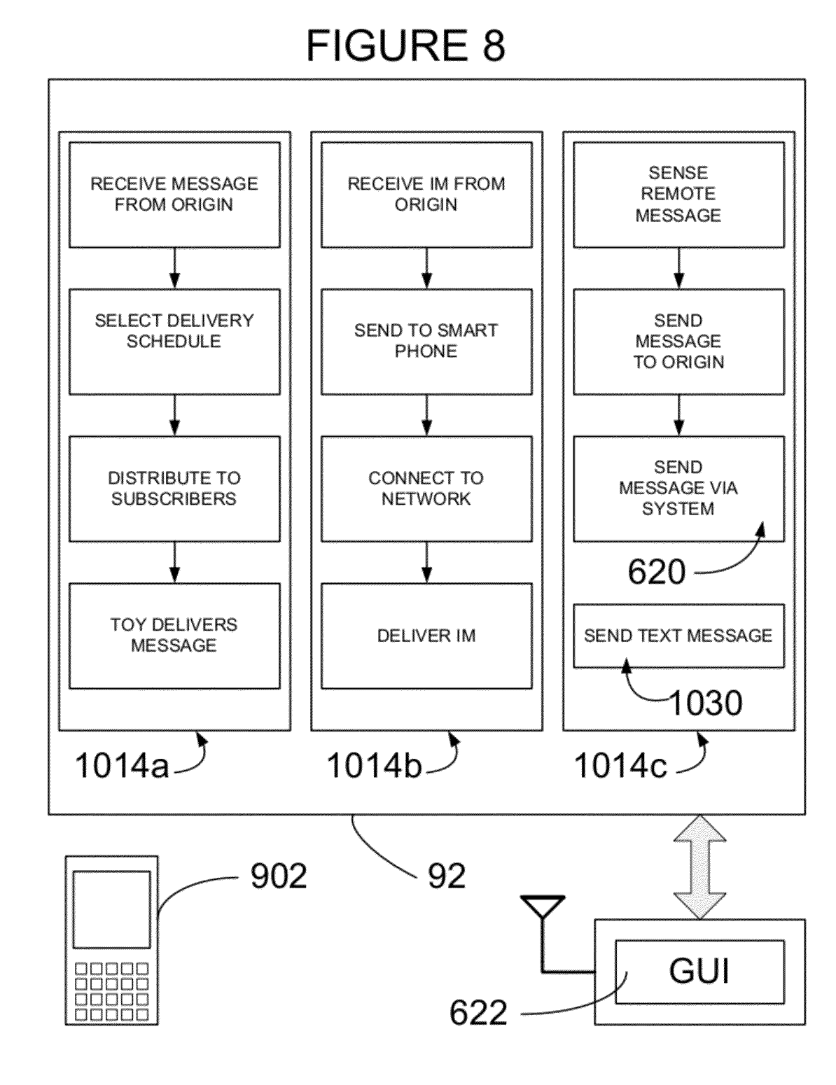

FIG. 6 is a block diagram of an intelligent device subsystem 90. The intelligent device subsystem 90 will be further discussed in relation to FIG. 7a, which illustrates a graphical communications applications menu. FIG. 8 illustrates a suite of applications that may be selected from the menu of FIG. 7a, and FIG. 7b, which illustrates a display which may be provided on the interactive device to provide a two-dimensional or 3D avatar which may communicate with the user, giving the impression of communication from an interactive toy.

In FIG. 6, the intelligent device subsystem 90 is illustrated as a smart phone 902. It is not essential that the intelligent device be characterized as a telephone or a computer. The intelligent device subsystem 90 should have communication capabilities described herein for functioning in the present system. At the heart of communications in the smart phone 902 is a baseband processor 920 coupled to interact with communications links further described below. An RF transceiver 924 couples the intelligent device 902 to the cell phone system 904 (FIG. 2). A Bluetooth transceiver 926 may provide the user 1 with communication to the intelligent device subsystem 90 by a headset 928 including earphones and a microphone or by another local device. A wireless local access network (WLAN) interface 930 provides for a direct Internet link. A common form of WLAN is a Wi-Fi connection. Wi-Fi is a trademark referring to devices from a source that produces interfaces that meet standards within the IEEE 802.11 standards group. Commonly, intelligent device subsystem 90 will also include an assisted global positioning system (A-GPS) receiver 932.

Information is exchanged between the baseband processor 920 and an audio codec 936 via an I2S communications bus 938, also known as Inter-IC Sound Integrated Interchip Sound bus. The codec 936 provides inputs to and outputs from audio devices, e.g., an internal microphone 940, an external microphone jack 942, a headphone jack 944, and a speaker 946.

The codec 936 exchanges data with an applications processor 950. The applications processor 950 handles data processing functions and works with user devices that may communicate with the smart phone 902. The user device is a liquid crystal display (LCD display) 954, touch screen keypad 956, touch screen controller 958, and LCD controller 960. Various applications are preloaded in the smart phone 902. Additionally, applications may be installed in the applications processor 950 from external sources. Accessibility to externally provided applications may be provided by a USB port 910 connected to the applications processor 950.

FIG. 7a illustrates a graphical menu 1010 which is displayed on the LCD display 954 integral to a smart phone 902. The graphical menu 1010 comprises an array of applications 1014. In a preferred form, touch screen functionality is provided so that selected ones of applications 1014 can be selected. Particular routines are further described in connection with FIG. 8, which illustrates a group of applications 1014 and which is also illustrative of programmed media which can be operated to perform the routines embodied in the applications. FIG. 7b illustrates an alternative display which comprises an avatar 1040. When the message from the character 8 is sent to the intelligent device 902, the LCD display 954 is switched to display the avatar 1040. Then the avatar 1040 speaks to a user 1 rather than having the figurine 6 speak to the user 1.

As seen in FIG. 8, an application 1014a grabs messages transmitted from the source module 80 (FIG. 2). The application forwards the call to a transceiver which couples the instantaneous message to the figurine 6. Additionally, the application 1014a includes a user interface to accept instantaneous natural-voice messages.

Intelligent device subsystem 90 (FIG. 2) comprises a further application 1014c which can detect reception of a recorded voice from a message board, and then can dial a call to access a recorded voice message. The recorded voice message is encoded and transmitted to a server, for example the server 706 in the server module 70. The server module 70 may transmit the message to the source module 80. The source module 80 can then handle the transmission of a new message originating from the character 8. In this manner, the character 8 can provide an input to the source module 80 for transmission in accordance with the options described. Routine 1014b provides messaging.

Alternatively, the user 1 may select a routine 1014c within intelligent device 902. The routine 1014c allows the user to enter text messages. New text messages are encoded in an e-mail, or by other means, and sent to the server 706 (FIG. 5) at block 1030. The text messages may be translated via the source module 80 and function as original inputs from the character 8.

FIG. 9 illustrates server applications for personalizing messages or other content. Also, content control may be provided. In a routine 1100, a message is directed from the source module 80 to the server 706 at block 1102. The subscriber database 720 is queried as to whether an addressee is a subscriber to personalized service at block 1104. If not, at block 1106, operation goes to block 1108, and a general message is transmitted. If a user 1 is subscribed, personalizing takes place block 1110 using information from fields in databases. A message frame is filled at block 1112, and a personalized message is transmitted at block 1114. In one embodiment, the personalization message may comprise selection of media content for provision to a user 1 selected in accordance with characteristics provided from the data monitor 750 (FIG. 5).

Personalization of content may be achieved using a content provision iterative algorithm. In one form, the system carries a predetermined data input indicative of the nature of content. This data input may comprise the additional signals that are currently provided along with radio transmissions or with media playable on Apple devices.

A number of parameters are used to calculate a number that is compared to a stored number in the user station 50. In one example, the following procedure is used to calculate a value:
Parental control and character complexity coefficients are populated
Iterate to add coefficient for popularity based on requests for content
Iterate to add coefficient for market penetration based on sales figures

Weighting of coefficients to be slanted to favor parental control and appropriateness of content. The number is then calculated by use of the relationship

C=W^{̂PC}*X^{̂CC}*Y^{̂PT}*Z^{̂MP} (1)

where C=, W=, X=, Y=, Z=, and further

where PC=parental control, CC=character complexity, PT=popularity trending, and MP=market penetration.

The present system may further provide for broadcast of live, personalized, instantaneous voice messages via a smart phone 902 (FIG. 8). The character 8 may operate a mobile device to provide personalized messages. Alternatively, a mobile device can receive text message or voice memo sent by e-mail and transcode the message and enable transmission from the source module 80.

In one subscription mode, all transmissions from the source module 70 are provided via the Internet 60 and the user station 50 (FIG. 2) to the figurine 6. In another form, the source module 80 is operated to provide a code to the server module 70 to indicate that a current communication is to be provided to authorized recipients and played directly.

FIG. 10 is an illustration of the encoding of signals representing the physical functions of the figurine 6. A tactile motion sensor 1200 is provided in order to automate the coding of animatronic functions. For example, an analog to digital converter 1220 receives inputs from a strain gauge 1222 on an arm 1224 of the figurine 6. A stored command number is produced which will correspond to the physical force applied by a servomotor 1226 to move the arm 1224 to the position sensed by the strain gauge. In this manner, the number that is produced in response to physical action may be accessed from storage and “played back” to produce a corresponding physical motion.

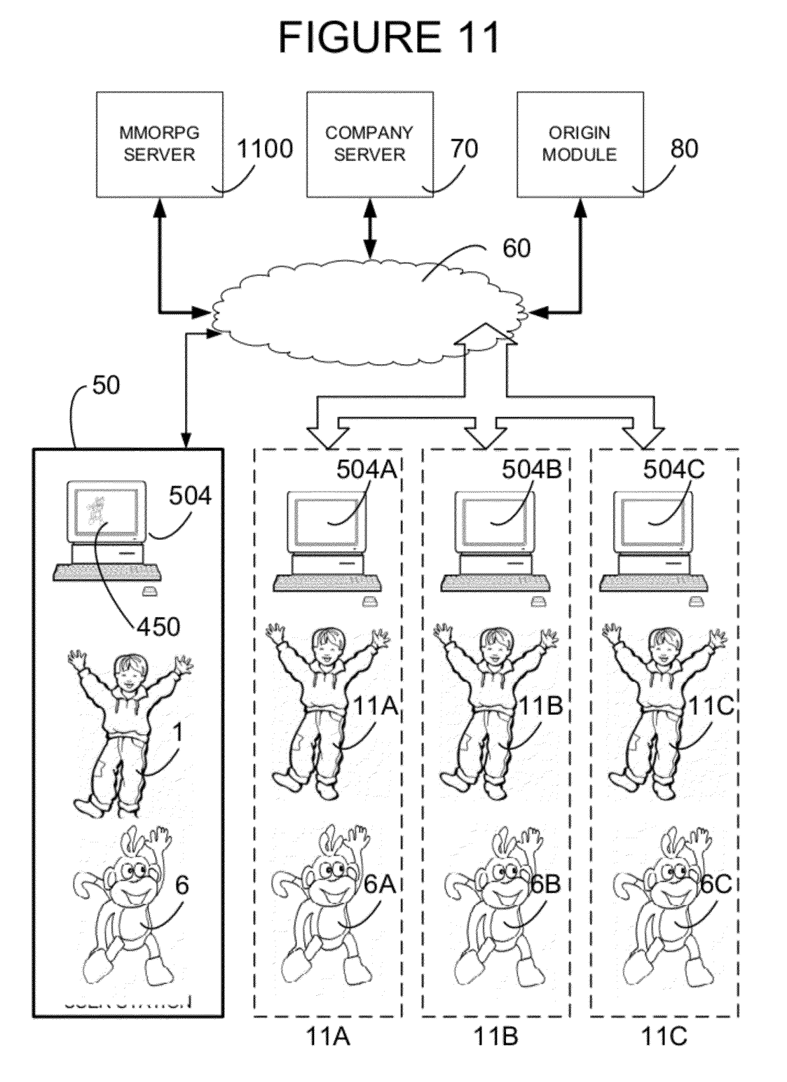

FIG. 11 illustrates the use of the figurine 6 as a proxy player in online game play. The figurine 6 may be connected to a game machine at the user station 50 (FIG. 2). Alternatively, the figurine 6 may be coupled via the computer 504 to a multiplayer online game from a server such as the server 1100. Other servers may be accessed via the Internet 60. The figurine 6 in the performance section 164 (FIG. 3) is provided with a database of plug-in or downloaded data indicative of inputs to be received in the game. The user 1 may access the database to tell the figurine 6 what to do. Commands may include, “shoot,” “duck,” or other functions in accordance with the rules and protocols of a particular game.

Commands also may be received as part of personalized messages from a transmission broadcast to subscribers. Commands can also be inserted into scenarios. First and second pairs of a figurine and character 6-A, 11-A and 6-B and 11-B and 6-C and 11-C are provided. Each member of a first set of subscribers A would have commands relayed to their interactive toys 6-A from a first character 11-A. Each member of a second set of subscribers B would have commands relayed to their interactive toys 6-B from a second character 11-B. In a further form, the toy game processor would respond to significant message words, decode these words locally, and produce the command signal locally.

These are only some of the possible scenarios that can be provided.

What is claimed is:

1. A communication system comprising a user module, an interactive device module, a server module, and a source module, wherein:
A. said user module comprises:
a. processor;
b. interfaces for communication with the server module and selected ones of said interactive device module and said source module;
c. connectivity devices;
B. said interactive device module comprises:
a. a figurine;
b. communication interfaces;
c. a processor for producing and responding to intelligence-bearing signals; and
d. transducers for selectively operating in response to or generating intelligence-bearing signals;
C. said server module comprises:
a. a server operation system connected to operate as a control center for transmission and translation of messages;
b. a network interface;
c. a data section for storing selected ones of data entities; and
d. a message processor for communicating with the user module; and
D. said source module comprises:
a. an intelligence source for providing information to be received by the interactive device module; and
b. a user interface comprising an applications processor coupled for controlling provision of information to the server operation system.

2. A communication system according to claim 1 wherein said connectivity device in said user module comprises a mobile media device and the processor is located in the mobile media device.

3. A communication system according to claim 1 wherein said connectivity device in said user module comprises a computer and the processor is located in the computer.

4. A communication system according to claim 1 wherein the processor in said user module comprises and internet interface.

5. A communication system according to claim 4 wherein said the processor contains commands for selectively connecting to the server module or the source module via the Internet interface.

6. A communication system according to claim 1 wherein the communication interfaces comprise a transmitter and a receiver.

7. A communication system according to claim 1 wherein the processor in the interactive device module provides signals to a decoder and wherein the decoder translates intelligence-bearing signals into action commands coupled to a transducer.

8. A communication system according to claim 1 wherein a transducer generates a signal in response a physical parameter and comprising an encoder for translating signals indicative of the physical parameter into intelligence-bearing signals.

9. A communication system according to claim 8 wherein at least one transducer comprises a transducer translating actionable intelligence into an output perceivable by a user.

10. A communication system according to claim 1 wherein the source module is operatively coupled to provide recorded voice messages.

11. A communication system according to claim 10 wherein the interactive device module delivers messages to the user via the figurine.

12. A communication system according to claim 1 wherein a data entity stored in the database in said server module comprises a character simulation database including a phoneme library for translating signals into the voice of a selected individual

13. A communication system according to claim 1 wherein a data entity stored in the database in said server module comprises a subscriber database identifying subscribers and services authorized to be used by each subscriber.

14. A communication system according to claim 13 further comprising a personalization database including subscriber information for personalizing general communications to individual subscribers.

15. A communication system according to claim 14 wherein personalizing comprises selecting content to be delivered to a subscriber and the subscriber information comprises preference or control data.

16. A communication system according to claim 15 wherein the control data comprises parental control data.

17. A communication system according to claim 1 wherein the interactive device module comprises a circuit storing capability data indicating types of data to which the figurine will respond and including means responsive to an interrogation signal for transmitting a capability signal indicative of the capability data in response to an interrogation.

18. A communication system according to claim 17 further comprising an interrogation circuit for producing an interrogation signal to initiate an interrogation and to receive a capability signal, and further comprising a processor to process the capability signal to indicate the capabilities, said circuit being located in said user operation system or the server module.

19. A communication system according to claim 18 wherein the interrogation circuit further comprises a processor for translating incoming information into a single stream of code embodying control signals.

20. A communication system according to claim 1 wherein said source module is connectable to selected sources of media.
